(19) United States
(12) Patent Application Publication
(10) Pub. No.: US 2014/0059258 A1
(43) Pub. Date: Feb. 27, 2014

(54) ELECTRONIC DEVICE AND METHOD FOR BACKING UP USERS OPERATION INFORMATION

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: YA-GUO WANG, Shenzhen (CN); CHUN-CHING CHEN, New Taipei (TW)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/866,010

(22) Filed: Apr. 18, 2013

(30) Foreign Application Priority Data
Aug. 22, 2012 (CN) 2012103003638

(51) Int. Cl. G06F 13/10

(52) U.S. Cl. CPC G06F 13/10
USPC 710/74

(57) ABSTRACT

An electronic device capable of switching between a normal mode for recording users' operation information and a testing mode for allowing testers to analyze the recorded users' operation information, is provided. The electronic device includes an interface allowing an external device having a storage module to be electronically connected thereto, a detecting unit for detecting when the external device is electronically connected to the interface port when the electronic device is put into the testing mode, and a processor backing up the stored users' operation information to the external device if the external device having a sufficient available capacity is electronically connected to the interface port. A method for backing up users operation information is also provided.

### BACKGROUND

1. Technical Field

The present disclosure relates to electronic devices, and more particularly to an electronic device able to record users' operation information and a method for backing up the recorded users' operation information.

2. Description of Related Art

User's incorrect operations may cause malfunction of electronic devices, such as portable DVD player, thus user's operation information need to be recorded for analyzing the malfunction. However, due to the amount of the recorded user's operation information, the recorded user's operation information needs to be manually collected and backed up to computers, for later analysis, which is troublesome.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an electronic device in accordance with an embodiment.

FIG. 2 is a flowchart of a method for backing up user's operation information in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

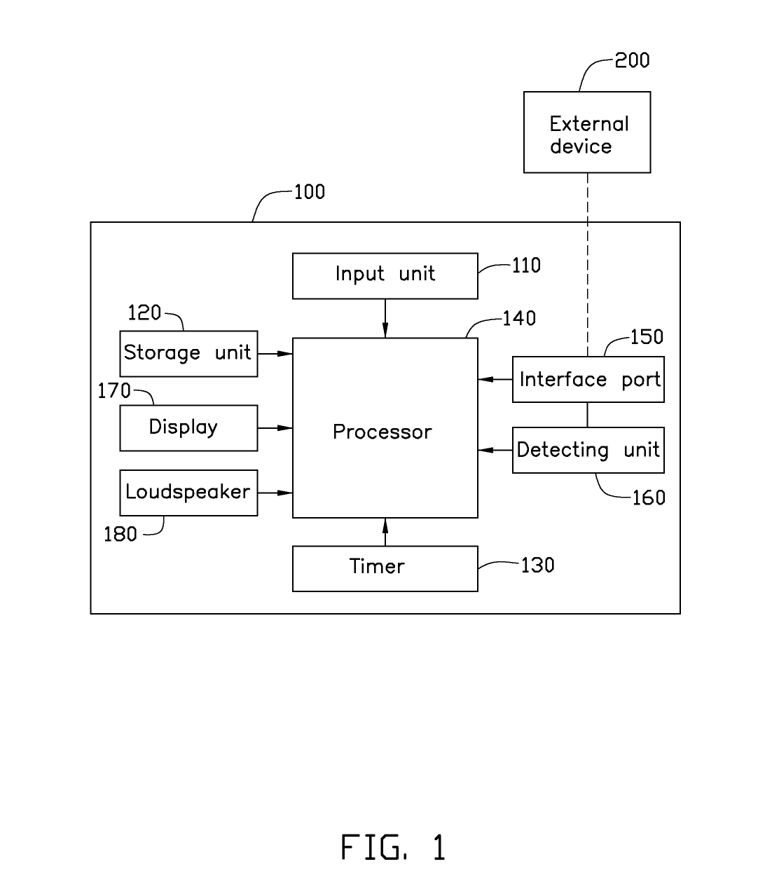

Referring to FIG. 1, an electronic device 100 capable of being electronically connected to an external device 200 having a storage module is provided. The electronic device 100 is capable of being switched between a normal mode and a testing mode, wherein the normal mode includes a working state, a standby state and an off state. When users operates the electronic device 100 by pressing keys and/or buttons mounted thereon, the electronic device 100 records user's operation information when in normal mode. The user's operation information includes at least the functions executed in response to user's operations, the key code of the keys/buttons operated by users, and the time of user's operations. The electronic device 100 further displays the recorded user's operation information for allowing analysis by users when in the testing mode. The electronic device 100 may be a portable DVD player, or a set-top box. The electronic device 100 in the embodiment is a portable DVD player.

The electronic device 100 includes an input unit 110, a storage unit 120, a timer 130, a processor 140, and an interface port 150. The electronic device 100 further includes a detecting unit 160, a display 170 and a speaker 180.

The input unit 110 generates signals in response to user operations. The input unit 110 can be a plurality of keys and/or buttons, or a touch panel mounted on the electronic device 100, and can also be a remote device for remotely controlling the electronic device 100.

The storage unit 120 stores data, such as images, video, and system parameters. The storage unit 120 in the embodiment is an Electrically Erasable Programmable Read-Only Memory (EEPROM) device.

The processor 140 executes functions of the electronic device 100 in response to the operating signals, and further records user's operation information in sequence when the electronic device 100 is in the normal mode. For example, when a power switch with the key code being 100100 is pressed to turn on the electronic device 100, on May 13, 2012 at 12:00, the processor 140 receives an operating signal generated by the power switch, and turns on the electronic device 100. Simultaneously, the processor 140 records this user' operation information as follows: key code: 100100, the electronic device 100 is started on May 13, 2012 at 12:00, and then stores the recorded users' operation information in the storage unit 120. When the volume button with key code 001001 is then operated to turn down the volume on the electronic device 100 to a certain level (for example, level 20) on May 13, 2012 at 12:05, the processor 140 receives an operating signal generated by the volume button, and turns down volume on the electronic device 100. Simultaneously, the processor 140 records this user' operation information as follows: key code: 001001, the volume on the electronic device is turned down to level 20 on May 13, 2012 at 12:05, and stores the recoded users' operation information in the storage unit sequentially.

The interface port 150 allows an external device 20 having a storage module to be electronically connected thereto. The external device 20 may be a computer, or an external storage device capable of being electronically connected to a computer. The interface port 150 in the embodiment is USB (Universal Serial Bus).

The detecting unit 160 detects when an external device 200 is electronically connected to the interface port 150 when the electronic device 100 is in the testing mode, and generates a detection signal if an external device is found to be electronically connected to the interface port 150 when the electronic device 100 is in the testing mode.

The processor 140 further backs up the user's operation information stored in the storage unit 120 to the external device 200 in response to the detection signal. In detail, when the electronic device 100 is in the testing mode, if an external device 200 is found to be electronically connected to the interface portion 150, the processor 140 firstly obtains the available capacity of the storage module of the external device 200, and compares the available capacity of the external device 200 with the stored users' operation information. If the available capacity of the external device 200 is sufficient to store the users' operation information, the processor 140 further automatically backs up the user's operation information stored in the storage unit 120 to the external device 200. If the available capacity of the external device 200 is insufficient in capacity, the processor 140 further generates a message for informing the tester that the capacity of the external device 200 is not enough, and the process of backing up the users' information cannot proceed. The message may be a cartoon or some other interesting image displayed on the display 170. In another embodiment, the message may be audible, output by the speaker 180.

The electronic device 100 provides a special key for activating the electronic device 100 to enter the testing mode. The electronic device 100 can also provide a menu item for selecting the testing mode for the electronic device 100.

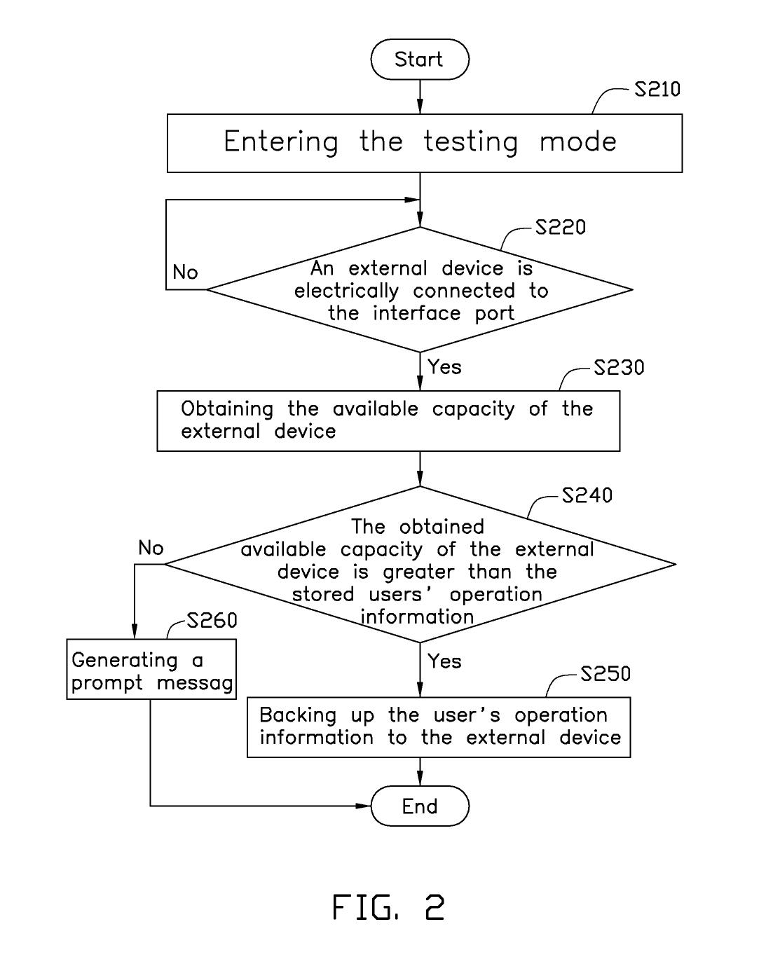

Referring to FIG. 2, a method for backing up users operation information is provided. The method is applied in the electronic device 100. The electronic device 100 is capable of recording user's operation information when users operate the electronic device 100 by pressing keys and/or buttons mounted thereon. The user's operation information includes at least the functions executed in response to user's operations, the key codes of the keys/buttons operated by users, and the times of user's operations. The electronic device 100 may be a portable DVD player, a set-top box. The method includes the following steps:

In step S210, the electronic device 100 is activated to enter the testing mode. A special key or a menu item may be provided for activating the electronic device 100 to enter the testing mode.

In step S220, the detecting unit 160 detects when an external device is electronically connected to the interface port 150. If yes, the procedure goes to step S230. If no, the procedure returns to S220.

In step S230, the processor 140 obtains the available capacity of the external device 200.

In step S240, the processor 140 further determines whether the available capacity of the external device 200 is sufficient to store the users' operation information. If yes, the procedure goes to step S250. If no, the procedure goes to S260.

In step S250, the processor 140 automatically backs up the user's operation information stored in the storage unit 120 to the external device 200.

In step S260, the processor 140 further generates a message for warning that the available capacity of the external device 200 is insufficient for storing the users' operation information. The warning message may be a cartoon or some other interesting image displayed on the display 170. In another embodiment, the prompt message may be a sound outputted by the speaker 180.

Although information as to, and advantages of, the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. An electronic device capable of recording users' operation information and being electronically connected to an external device, comprising;
an interface portion for allowing an external device to be electronically connected thereto;
a detecting unit for detecting when the external device is electronically connected to the interface port and a available capacity of the external device is sufficient to store the users' operation information; and
a processor backing up the stored users' operation information to the external device if the external device is found to be electronically connected to the interface port and the available capacity of the external device is sufficient to store the users' operation information.

2. The electronic device of claim 1, further comprising an input unit for receiving users' operations, wherein the input unit comprises at least one key having a key code.

3. The electronic device of claim 2, wherein the users' operation information comprises at least the functions executed in response to user's operations, the key code of each key operated by users, and the times of user's operations.

4. The electronic device of claim 3, further comprising a timer for timing real time.

5. The electronic device of claim 1, wherein the processor obtains the available capacity of the external device when an external device is found to be electronically connected to the interface port, and compares the obtained available capacity of the external device with the stored users' operation information, and further backs up the user's operation information to the external device if the obtained available capacity of the external device is sufficient for the stored users' operation information.

6. The electronic device of claim 1, wherein the electronic device is capable of switching between a normal mode for recording users' operation information and a testing mode for allowing testers analyzing the recorded users' operation information.

7. The electronic device of claim 6, wherein the processor executes functions of the electronic device in response to users' operations, and further records user's operation information sequentially when the electronic device is in the normal mode.

8. The electronic device of claim 7, wherein when the electronic device is in the test mode, the processor backs up the recorded users' operation information to the external device if the external device is found to be electronically connected to the interface port.

9. An electronic device capable of switching between a normal mode for recording users' operation information and a testing mode for allowing testers to analyze the recorded users' operation information, comprising;
an interface portion for allowing an external device to be electronically connected thereto;
a detecting unit for detecting when the external device is electronically connected to the interface port in the testing mode and the available capacity of the external device is sufficient to store the users' operation information; and
a processor backing up the stored users' operation information to the external device if the external device is found to be electronically connected to the interface port in the testing mode and the available capacity of the external device is sufficient to store the users' operation information.

10. The electronic device of claim 9, further comprising an input unit for receiving users' operations, wherein the input unit comprises at least one key having a key code.

11. The electronic device of claim 10, wherein the users' operation information comprises at least the functions executed in response to user's operations, the key code of each key operated by users, and the times of user's operations.

12. The electronic device of claim 11, further comprising a timer for timing real time.

13. The electronic device of claim 10, wherein the processor obtains the available capacity of the external device when an external device is found to be electronically connected to the interface port, and compares the obtained available capacity of the external device with the stored users' operation information, and further backs up the user's operation information to the external device if the obtained available capacity of the external device is sufficient for the stored users' operation information.

14. A method for backing up users operation information recorded by an electronic device, the electronic device capable of being electronically connected to an external device and capable of being switched between a normal mode for recording users' operation information and a testing mode for allowing testers to analyze the recorded users' operation information, the method comprising:
activating the electronic device entering to the testing mode;
detecting when the external device is electronically connected to the electronic device in the testing mode and the available capacity of the external device is sufficient to store the users' operation information; and
backing up the users' operation information to the external device if the external device is found to be electronically connected to the interface port when the electronic device enters to the testing mode and the available capacity of the external device is sufficient to store the users' operation information.

15. The monitoring method according to claim 14, further comprising:
obtaining the available capacity of the external device when an external device is found to be electronically connected to the interface port;
determining whether the obtained available capacity of the external device is sufficient for the stored users' operation information; and
backing up the user's operation information to the external device if the obtained available capacity of the external device is sufficient for the stored users' operation information.

16. The monitoring method according to claim 14, wherein the users' operation information comprises at least the functions executed in response to user's operations, the key code of each key operated by users, and the time of user's operations.
